(19) United States
(12) Patent Application Publication
(10) Pub. No.: US 2012/0200076 A1
(43) Pub. Date: Aug. 9, 2012

(54) CRYPTOGRAPHICALLY SECURED STOCK FOR USE WITH ONLINE POSTAGE SYSTEMS

(75) Inventors: Vladimir Golos, Shelton, CT (US); Daniel Lanin, New York, NY (US)

(73) Assignee: PITNEY BOWES INC., Stamford, CT (US)

(21) Appl. No.: 12/983,218

(22) Filed: Dec. 31, 2010

(51) Int. Cl. B42D 15/00; G06F 21/00

(52) U.S. Cl. 283/73; 726/26

(57) ABSTRACT

An illustrative label stock and associated systems and methods for identifying and utilizing sheets of label stock in online postage systems are described. In one configuration, a label stock is provided that includes a cryptographically secured serial number. The uppercase letters of the modern English alphabet are utilized in a character string to provide a serial number string component and a cryptographic check string component. The check string includes all or part of a cryptographic hash function output based upon the serial number string and the cryptographic hash function. The character string includes the serial number characters and the check string characters in an interspersed format.

### BACKGROUND

The illustrative embodiments described in the present application are useful in systems including those for identifying, authenticating and utilizing printing stock and more particularly are useful in systems for identifying, authenticating and utilizing sheets of label stock in online postage systems. Traditional mailing machines with postage meters such as the DM800 systems commercially available from Pitney Bowes Inc. of Stamford, Conn. are used to print postage on envelopes or labels. Such mailing machines incorporate dedicated printers for printing evidence of postage payment in the form of postage indicia.

Additionally, several online postage systems have been approved for use by the UNITED STATES POSTAL SERVICE (USPS) that may use general purpose sheet printers or roll label printers including systems available from PITNEY BOWES INC of Stamford, Conn. For example, the SHIPSTREAM MANAGER and the CLICKSTAMP ONLINE (CSO) online Internet postage systems have been provided by Pitney Bowes Inc. to facilitate printing postage using a personal computer and general purpose printer.

In such systems, sheets of label stock may be used for printing online postage. Furthermore, some of the systems use sheet stock that is controlled in some way such as by using some form of serialization. In some of the systems, the sheets of stock may be serialized by having each blank stamp label on the sheet include a long numeric serial number that includes a sheet base number followed by an individual stamp number. Moreover, such long serial numbers are not cryptographically secured in any way. Such serial numbers may be subject to counterfeit attempts and may be too cumbersome for users to enter reliably into a computer user interface dialog box.

Accordingly, there is a need for at least a cryptographically secured sheet stock control in online postage systems.

### SUMMARY

The present application describes illustrative label stock, systems and methods for identifying, authenticating and utilizing sheets of label stock in online postage systems.

In one illustrative embodiment, a label stock is described that includes a cryptographically secured serial number. In this embodiment, the upper case letters of the modern English alphabet are utilized in a character string to provide a base 26 serial number and a base 26 cryptographic check string. There are several forms of the serial number string described that may each be used. For example, the character string may have 8, 10, 12 or 14 total characters consisting of a serial number string with an additional 3, 4, 5, or 6 characters dedicated to a hash check string. The hash check string includes all or part of a cryptographic hash function output based upon the serial number string and may be calculated using a cryptographic hash function such as SHA1. The character string may have the serial number characters and the check string characters arranged in one of many different permutations. In alternatives, alpha-numeric and case sensitive characters may be utilized. Additionally, alternative alphabets and special characters may be used.

In another illustrative embodiment, an online postage system is described that uses sheet postage label stock having a cryptographically secured serial number. In this embodiment, the serial number is used to identify and authenticate the stock and is used to protect against counterfeit attempts and user data entry errors. Furthermore, the serial number may be used to determine the next available postage label on the sheet of postage label stock.

In yet another illustrative embodiment, a method for operating an online postage system is described that uses sheet postage label stock having a cryptographically secured serial number. In this embodiment, the serial number is used to identify and authenticate the stock and is used to protect against counterfeit attempts and innocent user data entry errors. Furthermore, the serial number may be used to determine the next available postage label on the sheet of postage label stock.

Several additional alternatives are disclosed and described herein.

### BRIEF DESCRIPTION OF THE DRAWINGS

FIG. 1 is a schematic representation of an online postage system according to an illustrative embodiment of the present application.

FIGS. 2A-2B are schematic diagram representations of sheets of postage label stock according to an illustrative embodiment of the present application.

FIG. 3A is a schematic diagram representation of shipping label stock according to an illustrative embodiment of the present application.

FIG. 3B is a schematic diagram representation of roll of postage label stock according to an illustrative embodiment of the present application.

FIGS. 4A-4E are schematic diagram representations of a user interface of an online postage system according to an illustrative embodiment of the present application.

FIG. 5A is a flow chart showing a process for authenticating a sheet of postage label stock according to an illustrative embodiment of the present application.

FIG. 5B is a flow chart showing a process for determining the next available stamp location for a particular sheet of postage label stock according to an illustrative embodiment of the present application.

### DETAILED DESCRIPTION OF EMBODIMENTS

A serialized custom postage stock is described having a secure serial number string identifier. Systems and methods for using such serial numbers in a secure custom web postage application are also described. Traditionally, postage meters were used in the United States to provide convenient postal funds evidencing and accounting so that a user may conveniently pay for postage for a relatively large number of mail pieces. More recently, online postage systems have been used to process postage transactions. Several such systems are described in U.S. Pat. No. 6,619,544, U.S. Pat. No. 7,353,213, U.S. Patent Application Publication No. 2005-0065897 A1, Patent Application Publication No. 2003-0088518A1 and U.S. Patent Application Publication No. 2005-0138469 A1, all incorporated herein by reference in their entirety. The United States Postal Service published a draft specification entitled Performance Criteria for Information-Based Indicia and Security Architecture for Open IBI Postage Evidencing Systems (PCIBI-O), dated Feb. 23, 2000.

In certain online postage applications, it is desirable to used sheets of label stock that are controlled in some way, such as by requiring the use of stock that is serialized. Prior systems that use only sequential serial numbers that are not cryptographically secure are subject to counterfeit attempts and innocent user data entry errors. Accordingly, several of the embodiments described herein provide postage label stock that is cryptographically secured, such as by including a cryptographic hash in the serial number string.

There are several security and user interface concerns in dealing with providing secure serialized stock. The stock serial numbers should uniquely identify each sheet of stock and therefore must have a sufficient range of numbers for use over the life of the product. Moreover, the serial numbers should be secure so that they are not easily guessed in an attempt to counterfeit a sheet of custom stamps. An additional consideration is that the serial numbers must be typed into the light web client by a user to uniquely identify the sheet. For usability concerns, the serial number should not be too many characters. Additionally, the scheme should effectively limit input errors.

The advantages described above provide a short serial string that is less susceptible to errors and more user-friendly. Moreover, the cryptographic hash provides security such that the serial numbers are not easily guessed by a counterfeiter. The is also a need for secure stock serial numbers in an online postage product for keeping track of the position of the sheet that was last used for a stamp.

The illustrative embodiments of the present application solves the above mentioned problems by providing a secure serial number string that is only between 6 and 20 characters long including the serial number and the hash digits, such as a 10 character string. In at least one example herein, the serial number is secured using a cryptographic hash system resident only at the online postage provider's server and not at the client computer. Accordingly, a secret key may be used to create the hash values used in secure serial numbers such that it is not exposed to the client side computers. The hash characters may represent the entire hash string or a portion of it. Additionally, the hash characters may be interlaced with the serial number characters to make the serial number string appear random. In at least one example, the serial number string scheme uses only capital modern English, Latin based letters without numerals so that confusion between “L” and “1” or O and 0 does not present a problem. Alternatively, other character sets such as Greek, Russian, Korean or Japanese characters may be used. The user will not necessarily know which of the 10 characters constitute part of the serial number string and which constitute part of the security hash string. The serial number string interlace format is not necessarily published, but many different interlace formats are equally interchangeable and have the same or similarly effective utility.

The user is not necessarily aware that some of the serial string characters are hash characters, or where in the string they are placed. In fact, multiple non-overlapping formats of the serial string may be used. For example, two different serial numbers may have a different number of characters and/or a different number of serial or hash characters. Similarly, the placement of the hash characters may differ in non-overlapping serial number ranges. Moreover, the location of the serial number string on the stock may be used in the identification, and authentication process.

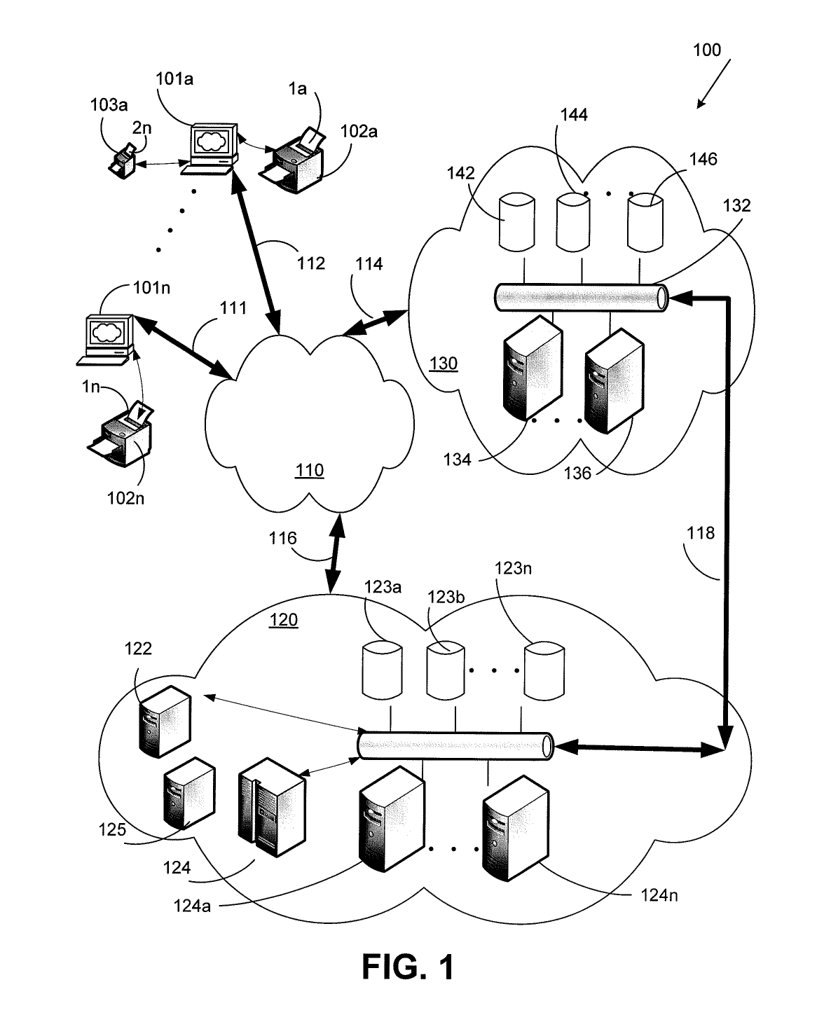

Referring to FIG. 1, a schematic representation of an online postage processing system 100 according to an illustrative embodiment of the present application is described. Here, a Cloud Computing based online postage system is described that utilizes several enterprise server system resources hosted by the postage provider or its traditional hosting vendors.

Several client-server application hosting paradigms have been used for hosting the server side of an application. For example, a company may host its own computing servers by operating traditional computing servers that may host a relational database on a non-shared basis. Such systems may also employ load balancing, geographical balancing and/or redundancy systems. Moreover, traditional hosting providers have offered such hosting services for their customers on a dedicated equipment basis. Traditional hosting providers have also offered hosting on shared resources and offered virtualized hosting and utility computing available on demand. Several companies market Cloud computing services including Amazon, Rackspace, Salesforce, Microsoft and Google. Such Cloud systems typically offer an Application Program Interface (API) specification for computing and storage instances and are typically marketed in terms of Quality of Service (QoS) levels and Service Level Agreements. However, the providers do not necessarily expose the inner workings of the system architecture and hardware components to customers. In the illustrative embodiments described herein, the MICROSOFT AZURE system will be used to illustrate the system. However, other Cloud and non-Cloud based storage systems may be utilized. In the MICROSOFT AZURE Cloud computing system, Computing Instances execute application logic for the client company. Similarly, Storage Instances store data for the client company.

An illustrative online postage vendor maintains a network 120 including an online postage system server 122 and several other application servers 124, 124a-124n and storage devices 123a, 123b-123n. The online postage vendor also utilizes a computer 125 that may be connected to the network 120 and that is used to generate batches of unique, cryptographically secured serial number strings using a cryptographic hash such as SHA1. The serial number strings may be globally unique over all time or may instead be unique over a range of time, geography, media type, vendor, postal system and/or other appropriate criteria. Similarly, used serial number strings might be reused after an appropriate period of time had passed.

In this example, the online postage vendor hosts a portion of the online postage system using a Cloud Computing provider having Cloud system 130. Accordingly, secure serial number identification, authentication and utilization is performed on a Computing Instance in the Cloud system. The online postage system services many thousand concurrent users who each access the system using client systems such as web browser enabled devices 101a-101n connected to one or more large public networks such as the Internet 110 using access provider communications channels 112, 111, respectively. The users also have sheet printers 102a, 102n for printing postage label stock 1a, 1n to create postage labels and label roll printers 103a for printing postage label roll stock and/or shipping labels.

The online postage company network 120 is also connected to the Internet 110 using communications channel 116. The online postage company network 120 may also be connected directly to the Cloud Computing provider system 130 using channel 118. The Cloud Computing provider system 130 is connected to the Internet 110 using communications channel 114. The schematic is illustrative and a typical configuration would include several Cloud Computing provider systems 130 and multiple servers 122 having geographical load balancing, volume load balancing and redundancy systems. For example, servers 122 may include a CLICK STAMP ONLINE server to provide secure postal indicia. Here, the Cloud Computing provider system 130 includes an internal network 132 such as ETHERNET or INFINIBAND connecting Computing and Storage instances. The Cloud computing instances are processed using servers 134, 136 and the Cloud storage instances are stored across storage nodes 143, 145, 147 with most of the inner-workings of the storage hidden from the online postage vendor.

The online postage vendor postage system 122 includes one or more servers that execute business logic and storage to provide an online postage product web services functionality including product usage rules and validation. The system 122 may utilize servers 124, 124a-124n to provide postage related functions including obtaining and providing postal labels and indicia, obtaining and providing postal rates and address cleansing, providing for carrier pickup notifications, providing for package tracking and providing insurance and other postal related functions. The enterprise system servers 124, 124a-124n are one or more servers that provide enterprise application support such as a common enterprise customer account login. Using an enterprise login, the system can ensure that a user identifier is unique across applications on the enterprise system. The enterprise servers 124, 124a-124n may provide customer account, product and funds management services to the system. The enterprise servers 124, 124a-124n may provide account creation and management along with the login services. An active directory may be used for authentication and a ping identity may be used to provide single sign-on services. The enterprise servers 124, 124a-124n may include a corporate web shopping cart access and reporting functions such as purchase reporting and postage dispense reporting. Similarly, the enterprise servers 124, 124a-124n may include payment functions such as check processing, POSTAGE BY PHONE available from Pitney Bowes Inc. of Stamford, Conn. and credit facilities. Moreover, the enterprise servers 124 may include subscription, billing, credit card processing and product management functions such as through a Customer Communications Management (CCM) system. The enterprise servers 124, 124a-124n may include distinct systems that are not related to postage such as systems providing user building access security.

The servers may be DELL POWEREDGE Servers and the client systems may include PCs such as DELL INSPIRON laptops or Dell OPTIPLEX desktops, each with associated displays, keyboards, mice, audio, video, processors, memory and disk storage subsystems. The Cloud devices may be MICROSOFT AZURE based. The clients may include smart phones, tablets, PDAs or other computing devices. The communications channels may be secured by VPN, HTTPS, SSL/TLS or other security system. The systems and subsystems here may be organized as different portions of an application, different applications on a computer or even different applications running on different computers. Similarly, any combination may be used or any known form of geographical, throughput or other load balancing may be used. The client and/or server logic may be written in JAVA, C++, C# or other system using a development environment such as VISUAL STUDIO.

In the illustrative online postage system 100, a user will utilize a web enabled device 101 to login and access a web based online postage system 100 using the Internet 110. If the user wishes to print on a sheet of postage label stock, the system will request a serial number string input corresponding to the sheet of stock. After the user types in the serial string, the system will identify and authenticate the sheet to protect against counterfeit attempts and innocent user data entry errors. Furthermore, the serial number may be used to determine the next available postage label on the sheet of postage label stock. For each serialized sheet of postage label stock, the online postage system stores an indication of the stamps already used and/or the next available stamp such as in Cloud storage 142 and/or in storage at 122 or 123a.

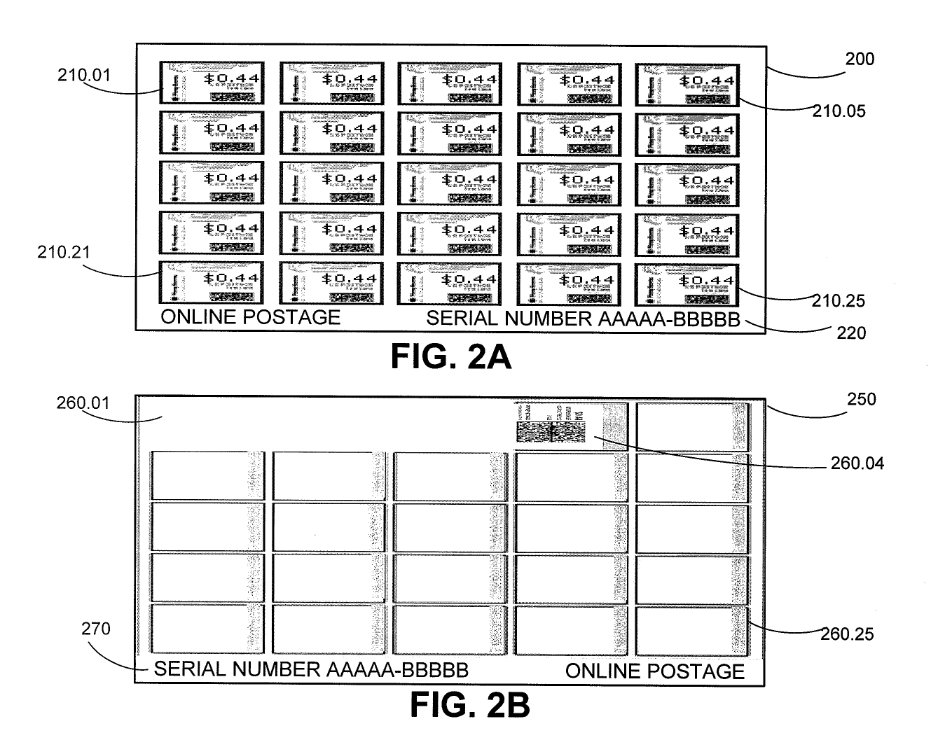

Referring to FIGS. 2A-2B, schematic diagram representations of sheets of postage label stock 200, 250 according to an illustrative embodiment of the present application are described. In one illustrative embodiment, a label stock 200 is described that includes a cryptographically secured serial number 220. Here, each sheet of postage label stock 200 includes 25 individual adhesive backed postage stamp labels 200.01-200.25 arranged as shown in FIG. 2A.

In another illustrative embodiment, a label stock 250 is described that includes a cryptographically secured serial number 270. Here, each sheet of postage label stock 250 includes 25 individual adhesive backed postage stamp labels 260.01-260.25 arranged as shown in FIG. 2B. The position of the serial number, e.g., bottom left may also be used as an input parameter to further identify and authenticate the sheet of stamp stock 250. As shown in FIG. 2B, some of the stamp labels 260.01 though 260.03 have previously been used when the user logs into the system. Accordingly, the secure serial number is used by the online postage system to determine the location of the next available postage label 260.04 in the sheet.

In this embodiment, the upper case letters of the modern English alphabet are utilized in a character string to provide a base 26 serial number and a base 26 cryptographic check string. In alternatives, other languages may be used. Similarly upper and lower case, numerals and special characters may be used. However, there may be ease of use benefits described herein when using only the upper case letters of the modern English alphabet. Moreover, there are several forms of the serial number string described that may each be used. For example, the character string may have 8, 10, 12 or 14 total characters consisting of a serial number string with an additional 3, 4, 5, or 6 characters dedicated to a hash check string. The hash check string includes all or part of a cryptographic hash function output based upon the serial number string and may be calculated using a cryptographic hash function such as SHA1. Other hash functions such as SHA2, MD5 or other appropriate security function may be used. The character string may have the serial number characters and the check string characters arranged in one of many different permutations.

There are several characteristics that may be desirable in a serialized postage label sheet stock. Initially, it is desirable in certain examples to have a unique serial number for each sheet of postage stamp label stock. Additionally, the serial number should be secure such that it is difficult for the customer or a user to guess available sheet numbers. Furthermore, it is desirable to provide a secure serial number that minimizes the number of characters a user must type but also provides an identification/authentication/validation mechanism that is also useful to detect innocent user typographical errors.

In one example, the 26 uppercase letters of modern English (Latin based) alphabet are used as set of characters to provide a base 26 number system. An illustrative secure serial number string is 10 characters long including 7 characters to provide a unique serial numeric sequence for each sheet of stock and 3 characters used for a signature. The 3 hash characters may include all of a hash, but typically would represent a certain number of bits or bytes of the hash string associated with the 7 character serial number sequence. An alternative illustrative secure serial number string is 10 characters long including 6 characters to provide a unique serial numeric sequence for each sheet of stock and 4 characters used for a signature. The 4 hash characters may include all of a hash, but typically would represent a certain number of bits or bytes of the hash string associated with the 6 character serial number sequence.

The SHA1 hash algorithm will output 160 bits of hash regardless of the size of the input string. Here, the same x number of bits will be encoded or converted into a number of hash string characters. In this example, in base 26 format. For example, the first x, last x or some other set of x hash bit may be utilized as appropriate. If additional sheets were required, another serial range could be used as an overlay by adding one or more characters and updating the system to recognize such new strings. Similarly, alternative character string formats may have 8, 10, 12 or 14 total characters consisting of a serial number string with an additional 3, 4, 5, or 6 characters dedicated to a hash check string. The serial number string characters and the hash check string characters may be interspersed in the string and do not need to be in significant digit order. For example, any of the formats of TABLE 1 could be used with Sx being a serial number string character and Hx being a hash check string character. Hyphenation or other punctuation may be used in the format.

TABLE 1
Secure Serial Number String Format

S1, S2, S3, S4, S5, S6, S7, H1, H2, H3
S7, S6, S5, S4, S3, S2, S1, H3, H2, H1
S1, S2, S3, S4, H1, S5, H2, S6, H3, S7
S1, H1, S2, H2, S3, H3, S4, S5, S6, S7
S1, H1, S2, S3, H2, H3, S4, S5, S6, S7
S1, H1, H2, H3, S2, S3, S4, S5, S6, S7
S1, S2, H1, H2, H3, S3, S4, S5, S6, S7
S1, S2, H3, H2, H1, S3, S4, S5, S6, S7
S1, S2, H2, H1, H3, S3, S4, S5, S6, S7
S1, S2, S3, S4, S5, S6, S7, H3, H2, H1
S2, S1, H1, H2, H3, S3, S4, S5, S6, S7
S2, S1, H3, H2, H1, S3, S4, S5, S6, S7
S2, S1, H2, H1, H3, S3, S4, S5, S6, S7
S1, S2, H1, H2, H3, S4, S3, S5, S6, S7
S1, S2, S3, S4, S5, S6, H1, H2, H3, H4
S6, S5, S4, S3, S2, S1, H4, H3, H2, H1
S1, S2, S3, S4, H1, S5, H2, S6, H3, H4
S1, H1, S2, H2, S3, H3, S4, H4, S5, S6
S1, H1, S2, S3, H2, H3, H4, S4, S5, S6
S1, H1, H2, H3, H4, S2, S3, S4, S5, S6
S1, S2, H1, H2, H3, H4, S3, S4, S5, S6
S1, S2, H4, H3, H2, H1, S3, S4, S5, S6
S1, S2, H2, H1, H4, H3, S3, S4, S5, S6
S1, S2, S3, S4, S5, S6, H4, H3, H2, H1
S2, S1, H1, H2, H3, H4, S3, S4, S5, S6
S2, S1, H4, H3, H2, H1, S3, S4, S5, S6
S2, S1, H2, H1, H4, H3, S3, S4, S5, S6
S1, S2, H1, H2, H3, H4, S4, S3, S5, S6
S1, S2, S3, S4, S5, S6, S7, S8, S9, H1, H2, H3
H1, H2, H3, S1, S2, S3, S4, S5, S6, S7, S8, S9
S1, S2, S3, S4, S5, S6, S7, S8, H1, H2, H3, H4
H1, H2, H3, H4, S1, S2, S3, S4, S5, S6, S7, S8

Computer system 125 may be used to compute batches of unique serial numbers to be used in creating the sheet of postage label stock 200, 250. The computer system 125 may be used to track previously issued sheet stock and it or another computer in the system may associate particular sheet of stock with individual postal indicium an/or users.

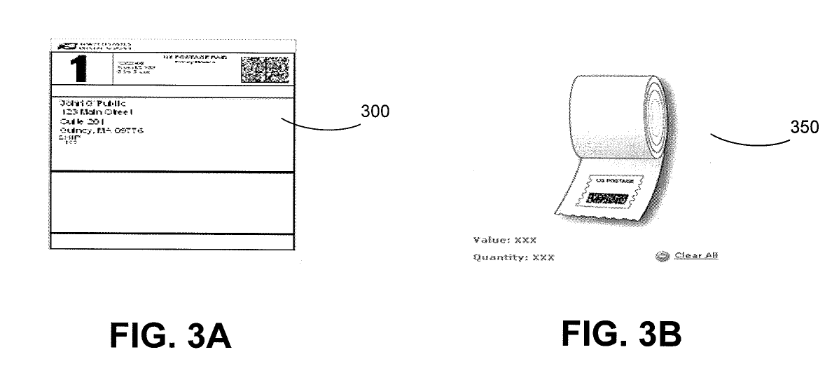

FIG. 3A is a schematic diagram representation of shipping label stock 300 according to an illustrative embodiment of the present application. In this example, a secure serial number string as described above may be used with shipping label stock provide as single label stock or roll of shipping label stock.

FIG. 3B is a schematic diagram representation of roll of postage label stock 350 according to an illustrative embodiment of the present application. In this example, a secure serial number string as described above may be used with roll postage label stock.

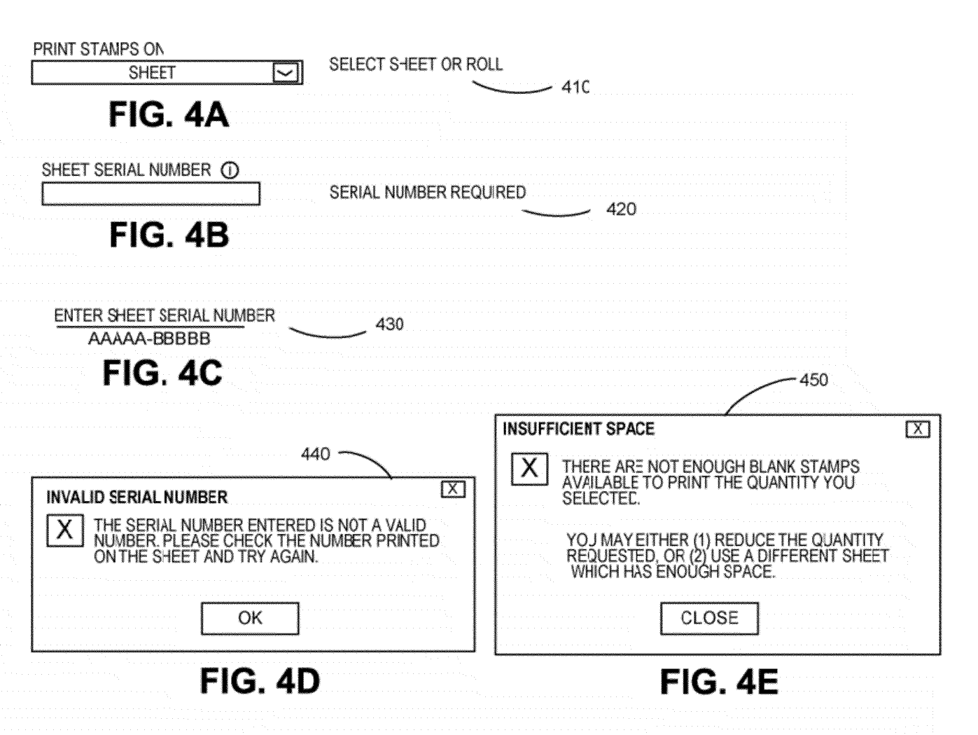

FIGS. 4A-4E are schematic diagram representations of a user interface of an online postage system according to an illustrative embodiment of the present application. As shown In FIG. 4A, the user is presented in the web interface at 101a, a selection box 410 to determine if sheet stock is being used. A s shown In FIG. 4B, the user is presented in the web interface at 101a, a text input box 420 requesting the serial number. The serial number is requested and the full serial number character string is required as the user is not necessarily aware that there are secure check characters in the string. If a serial number is not entered, a message stating that it is required is presented. As shown In FIG. 4C, the user is presented in the web interface at 101a, a text input box 430 and inputs the serial number. Hyphenation or other punctuation may be provided for the user or required to be typed.

If the user types an invalid serial number, a dialog box may be used to inform the user. For example, as shown In FIG. 4D, after the user types an invalid serial number in the web interface at 101a, a dialog box 440 provides an error message.

If the user types a valid serial number, but has requested more stamps than the number of available postal labels on the particular sheet of postage label stock, then a dialog box may be used to inform the user. For example, as shown In FIG. 4E, after the user types a valid serial number with an invalid number of stamps in the web interface at 101a, a dialog box 450 provides an error message.

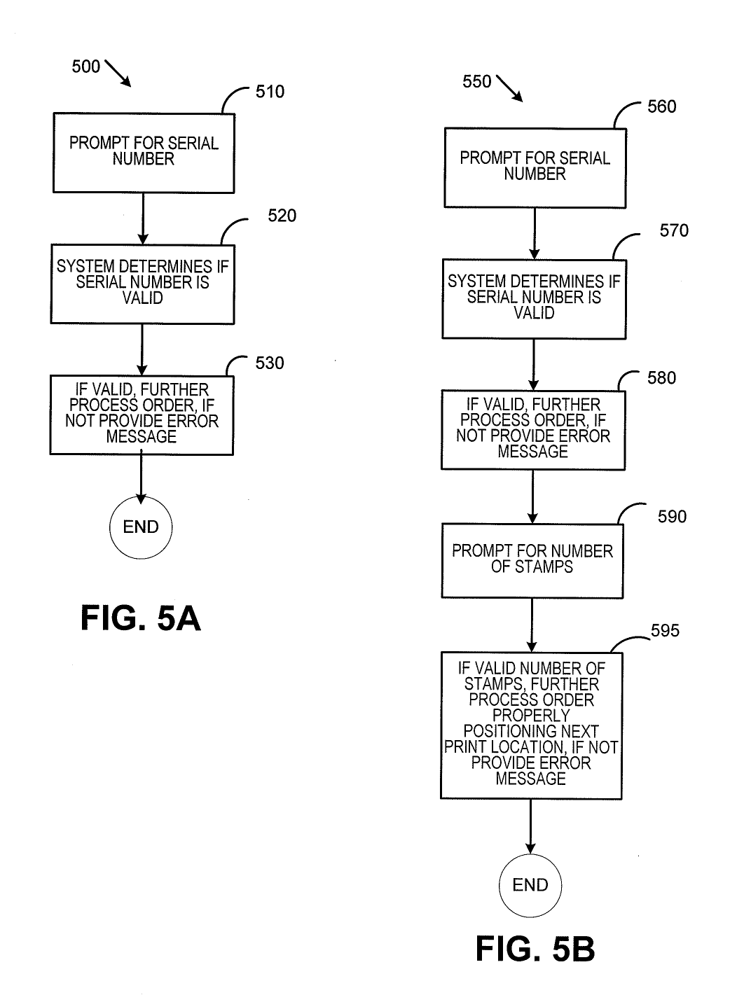

FIG. 5A is a flow chart showing a process 500 for authenticating a sheet of postage label stock according to an illustrative embodiment of the present application. In yet another illustrative embodiment, a method 500 for operating an online postage system 100 is described that uses sheet postage label stock 200 having a cryptographically secured serial number 220 is described. In this embodiment, the serial number is used to identify and authenticate the stock and is used to protect against counterfeit attempts and innocent user data entry errors.

In step 510, the user is prompted for the sheet of postage label stock serial number. In step 520, the system determines of the serial number is valid by decoding the serial number character string using the determined format to parse the serial number string and the check has string. The system then independently calculates the check hash string from the serial number string and compares it to the parsed check hash string. In step 530, the system further processes the postage request if the serial number is valid and provides an error message if the serial number is not valid.

FIG. 5B is a flow chart showing a process 550 for determining the next available stamp location 260.04 for a particular sheet of postage label stock 250 according to an illustrative embodiment of the present application. In yet another illustrative embodiment, a method for operating an online postage system is described that uses sheet postage label stock having a cryptographically secured serial number is described. In this embodiment, the serial number is used to determine the next available postage label on the sheet of postage label stock.

In step 560, the user is prompted for the sheet of postage label stock serial number. In step 570, the system determines of the serial number is valid by decoding the serial number character string using the determined format to parse the serial number string and the check has string. The system then independently calculates the check hash string from the serial number string and compares it to the parsed check hash string. In step 580, the system further processes the postage request if the serial number is valid and provides an error message if the serial number is not valid. In step 590, the user is prompted for the requested number of stamps. In step 595, the system determines if there are sufficient postage labels remaining on the requested sheet of label stock. If there are sufficient labels, the order continues. If the order continues, the system determines the appropriate position of the next stamp label to print by obtaining the number of stamps already used or by obtaining the next print location from memory storage associated with the particular sheet of postage label stock. If there are insufficient labels, an error message is provided with the option of changing input number of stamps requested or selected a new sheet of stock.

The present application describes illustrative embodiments of secure serialized postage label stock and online postage systems and methods. The embodiments are illustrative and not intended to present an exhaustive list of possible configurations. Where alternative elements are described, they are understood to fully describe alternative embodiments without repeating common elements whether or not expressly stated to so relate. Similarly, alternatives described for elements used in more than one embodiment are understood to describe alternative embodiments for each of the described embodiments having that element.

The described embodiments are illustrative and the above description may indicate to those skilled in the art additional ways in which the principles of this invention may be used without departing from the spirit of the invention. Accordingly, the scope of each of the claims is not to be limited by the particular embodiments described.

What is claimed is:

1. A postage label stock for use in preparing postage labels comprising:
a substrate having a plurality of postage labels,
the substrate further comprising a secure serial number string.

2. The postage label stock of claim 1, wherein,
the secure serial number string comprises a plurality of serial number characters and a plurality of security characters.

3. The postage label stock of claim 2, wherein,
the plurality of security characters are determined by performing a secure hash function on the plurality of serial number characters.

4. The postage label stock of claim 3, wherein,
the plurality of security characters are determined by encoding a portion of the output bits of the secure hash function.

5. The postage label stock of claim 3, wherein,
the secure hash function comprises SHA1.

6. The postage label stock of claim 2, wherein,
the secure serial number string comprises a string wherein the plurality of serial number characters are interspersed with the plurality of security characters according to a string format.

7. The postage label stock of claim 2, wherein,
the secure serial number string consists of uppercase modern English letter characters.

8. The postage label stock of claim 2, wherein,
the secure serial number string consists of uppercase modern English letter characters and punctuation.

9. The postage label stock of claim 1, wherein,
the secure serial number string is associated with a particular zone location of the substrate.

10. A computer program system being executed on a data processing and storage system for processing online postage requests from a user having a postage label stock including a secure serial number string comprising:
the data processing system executing instructions including,
obtaining the secure serial number string from the user,
determining if the secure serial number string is valid,
further processing the postage request if the serial number is valid and providing an error message if the serial number is not valid.

11. The computer program system of claim 10, wherein the secure serial number string comprises a plurality of serial number characters and a plurality of security characters and wherein the plurality of security characters are determined by performing a secure hash function on the plurality of serial number characters, further comprising:
the data processing system executing instructions including,
decoding the serial number string using a determined string format to parse the a plurality of serial number characters and a plurality of security characters,
independently calculating the plurality of security characters from the plurality of serial number characters, and
determining if the secure serial number string is valid if the independently calculated security characters match the decoded security characters.

12. The computer program system of claim 11, further comprising:
the data processing system executing instructions including,
obtaining a requested number of stamps from the user,
using the secure serial number string to determine if there are sufficient labels for the requested number of stamps,
allowing the order to continue of there are a sufficient number of stamps and providing an error message to the user if there are an insufficient number of stamps.

13. The computer program system of claim 12, further comprising:
the data processing system executing instructions including,
determining the appropriate position of the next stamp label to print on the postage label stock by using the secure serial number string, and
printing postage labels on the postage label stock using the appropriate position.

14. The computer program system of claim 13, wherein:
the secure hash function consists of the SHA1 hash function,
the postage label stock comprises a sheet of postage label stock, and
the data processing system includes a Cloud Computing system.

15. A method being executed on a data processing and storage system for processing online postage requests from a user having a postage label stock including a secure serial number string comprising:
obtaining the secure serial number string from the user,
determining if the secure serial number string is valid, and
further processing the postage request if the serial number is valid and providing an error message if the serial number is not valid.

16. The method of claim 15, wherein the secure serial number string comprises a plurality of serial number characters and a plurality of security characters and wherein the plurality of security characters are determined by performing a secure hash function on the plurality of serial number characters, further comprising:
decoding the serial number string using a determined string format to parse the a plurality of serial number characters and a plurality of security characters,
independently calculating the plurality of security characters from the plurality of serial number characters, and
determining if the secure serial number string is valid if the independently calculated security characters match the decoded security characters.

17. The method of claim 16, further comprising:
obtaining a requested number of stamps from the user,
using the secure serial number string to determine if there are sufficient labels for the requested number of stamps,
allowing the order to continue of there are a sufficient number of stamps and providing an error message to the user if there are an insufficient number of stamps.

18. The method of claim 17, further comprising:
determining the appropriate position of the next stamp label to print on the postage label stock by using the secure serial number string, and
printing postage labels on the postage label stock using the appropriate position.

19. The method of claim 18, wherein:
the secure hash function consists of the SHA1 hash function,
the postage label stock comprises a sheet of postage label stock, and
the data processing system includes a Cloud Computing system.
